(19) United States
(12) Patent Application Publication
(10) Pub. No.: US 2004/0016170 A1
(43) Pub. Date: Jan. 29, 2004

(54) Fixed/flying gaff

(76) Inventor: Mark Fitzgibbons, Orland Park, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/202,792

(22) Filed: Jul. 25, 2002

(51) Int. Cl. A01K 97/14

(52) U.S. Cl. 43/5

(57) ABSTRACT

The present invention is directed to a fixed/flying gaff that is easier to use, safer, and more effective for landing large fish than conventional types of gaffs. The fixed/flying gaff of the invention includes a gaff head that is detachably engaged with an elongated handle.

The present invention relates to a fixed/flying gaff which is effective for landing large fish. More specifically, the fixed/flying gaff of the invention is designed to easily penetrate a fish, remain securely in the fish, and be easily removed from the fish.

### BACKGROUND

When a large game fish such as a giant tuna, swordfish, shark, or marlin is taken by sportfishermen, the fish is played until it is depleted of energy and then gaffed to bring it into the boat. Typically, gaffs used to secure a large fish include a rounded end that must be place under or below a fish to penetrate its body.

A substantial amount of time must be undertaken to allow the fish to tire to the point of laying motionless so that a rounded style gaff hook can be used. During this time fisherman can be injured and often during this time the fish escapes. A rounded style gaff hook is very difficult to use on large gamefish such as sharks due to their thick skin. A rounded style gaff hook without serrated teeth does not lodge into the fish and will easily come out. Further, once the barb of a rounded style gaff penetrates a fish, it must be pulled back for removal, further damaging the flesh of the fish.

Once a gaff is inserted into a fish, the gaff head may separate from the gaff handle. The amount of force or shear needed to cause separation of the gaff head from the gaff handle is variable and cannot be predetermined by a user to provide a fixed predetermined breakaway shear strength.

### SUMMARY

The present invention is directed to a fixed/flying gaff effective for gaffing large fish. The fixed/flying gaff of the invention is easier to use, safer, and more effective for landing large fish than conventional types of gaffs. After landing the fish, the fixed/flying gaff can be easily removed without further damaging the flesh of the fish.

The fixed/flying gaff of the present invention includes a detachable gaff head that includes a hook portion extending from a hook shaft. The hook shaft includes serrated teeth and is attached to a detachable offset rope holder. The hook shaft extends past the offset rope holder to form a handle engagement portion that extends into an elongated handle. The elongated handle detachably engages the handle engagement portion and fixes the detachable engagement portion to the elongated handle with a fixed determined breakaway shear strength. The fixed predetermined breakaway shear strength may be provided by a wire, a cable, a rubber band, a plastic strap, and in a preferred aspect of the invention, by at least one shear pin or bolt. In the aspect of the invention where a shear pin is used, the shear pin provides a predetermined breakaway strength effective for allowing the elongated handle to release from gaff head. The detachable gaff head includes an offset rope holder with holes that are effective for allowing attachment to a rope, chain or cable.

In one aspect of the invention, the fixed/flying gaff includes a steel bolt(s) or a shear pin(s) to secure the handle engagement portion to the elongated handle. When a steel bolt or bolts are used to secure the handle engagement portion to the elongated handle, the detachable gaff head will not detach and will remain fixed on the elongated handle. When a shear pin or pins are used to secure the handle engagement portion to the elongated handle, the detachable gaff head will separate from the elongated handle at a predetermined breakaway strength and the detachable gaff head will remain securely in the fish.

Prior to using the fixed/flying gaff of the invention, a determination must be made to use the gaff as a fixed or flying gaff. If the detachable gaff head is to remain firmly attached to the elongated handle, a steel bolt or bolts will be used to attach the detachable engagement portion to the elongated handle. When the detachable gaff head penetrates the fish, the detachable gaff head will remain fixed on the elongated handle. If a user anticipates catching large fish that can not be pulled into the boat without risk of injury then a shear pin or pins are used to attached the handle engagement portion to the elongated handle. The detachable gaff head will detach from the elongated handle at a predetermined breakaway strength to become a flying gaff head.

Prior to using the fixed/flying gaff of the invention, the detachable head portion of the fixed/flying gaff is engaged with the elongated handle. At least one shear pin hole on the elongated handle is matched up with at least shear pin hole in the handle engagement portion of the detachable head portion of the fixed/flying gaff. At least one shear pin of predetermined strength or at least one bolt is inserted through the holes to secure the elongated handle to the detachable head portion. A rope, chain or cable is secured to one of the holes in the offset rope holder.

The fixed/flying gaff of the invention is put into use when a large fish is hooked. When the fish nears the boat, the fixed/flying gaff is thrust into the fish. In the aspect of the invention where the handle engagement portion is secured to the elongated handle by at least one shear pin, if the fish thrashes about and starts to move away from the boat, the shear pin will break, allowing the elongated handle and head portion of the fixed/flying gaff to separate.

The detachable fixed/flying gaff remains firmly attached to the fish due to a barb and serrated teeth. As the fish swims away from the boat, the rope, chain or cable secured to the offset rope holder and to the boat begins to tighten. As the rope, chain or cable tightens, the detachable fixed/flying gaff is pulled back in a direction opposite from which it entered the fish, thereby burying the barb deeper into the flesh of the fish. The serrated teeth prevent the barb from exiting the fish and as the fish struggles, the barb becomes more deeply buried into the fish. The detachable head portion of the fixed/flying gaff along with the fish may be retrieve by pulling in the rope or chain that was attached.

In an important aspect of the invention, the design of the fixed/flying gaff allows an entry point into the fish directly into vital organs as opposed to a traditional rounded gaff that only enters the fish in the belly or jaw. By thrusting the gaff directly into the vital organs as opposed to the belly or jaw, the fish becomes immediately incapacitated and the amount of thrashing is greatly reduced, thereby increasing the safety and success of the fisherman.

Upon landing of the fish, the offset rope holder may be removed and the fixed/flying gaff can be pushed forward through the fish and removed. Removing the fixed/flying gaff by pushing forward as opposed to pulling back, prevents further damage to the flesh of the fish.

### BRIEF DESCRIPTION OF THE DRAWINGS

FIG. 1 is a side view of a top portion of the fixed/flying gaff of the invention.

FIG. 2 is a side view of a top portion of another aspect of the invention.

FIG. 3 is a side view of a top portion of yet another aspect of the invention.

FIG. 4 is a side view of the fixed/flying gaff head of the invention.

FIG. 5 shows the fixed/flying gaff head of the invention with the offset rope holder detached.

FIG. 6 illustrates a top view of the fixed/flying gaff of the invention.

FIG. 7 is a back view of the fixed/flying gaff of the invention.

FIG. 8 is a back view of the fixed/flying gaff of the invention.

FIG. 9 is a perspective view of the fixed/flying gaff of the invention.

FIG. 10 is a side view of a U-shaped fixed/flying gaff of the invention.

### DETAILED DESCRIPTION

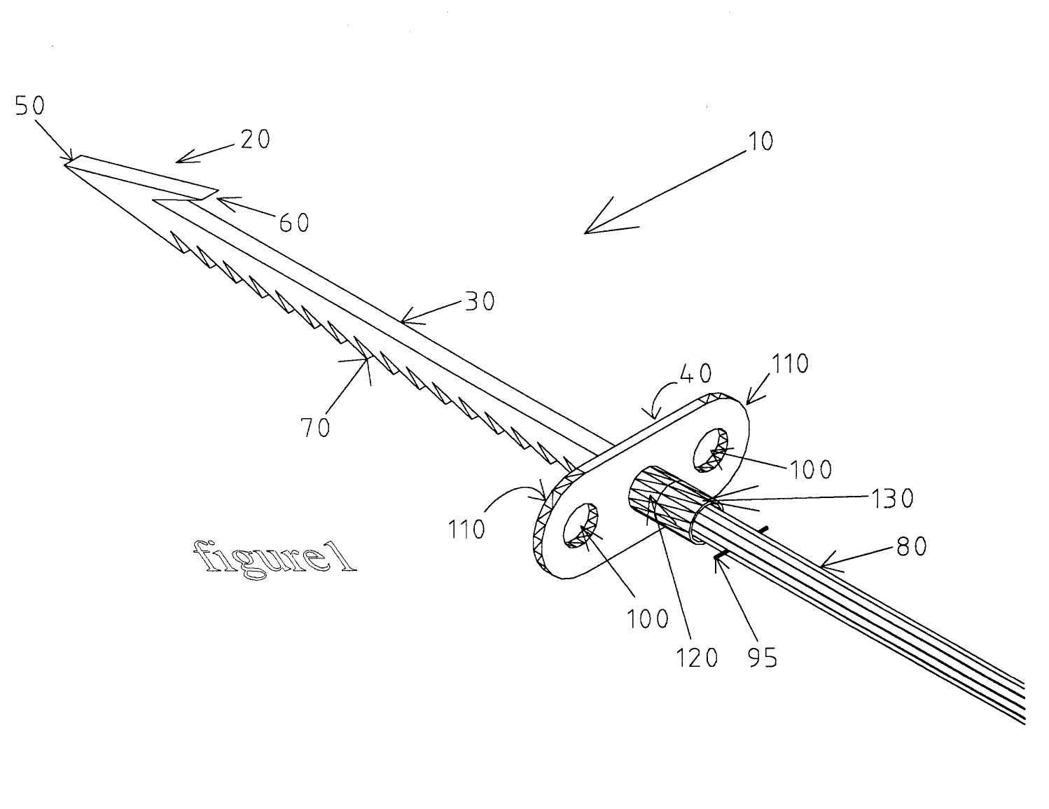

One aspect of the fixed/flying gaff of the present invention is shown in FIG. 1. The fixed/flying gaff 10 includes a hook portion 20 and a hook shaft 30. The hook shaft 30 is attached to and continues through a detachable offset rope holder 40. The hook portion 20 may include a hook point 50 and a hook barb 60. The hook point 50 is effective for providing additional penetrating ability when the fixed/flying gaff is thrust forward into a fish. In this aspect of the invention, the hook portion 20 includes a hook barb 60 that extends in an opposite direction from the hook point 50. The hook barb 60 is effective for further securing the fixed/flying gaff in the fish.

The hook shaft 30 may also include serrated teeth 70. The serrated teeth 70 may generally extend in an opposite direction from the hook point 50. The serrated teeth 70 are effective for further securing the fixed/flying gaff into the fish.

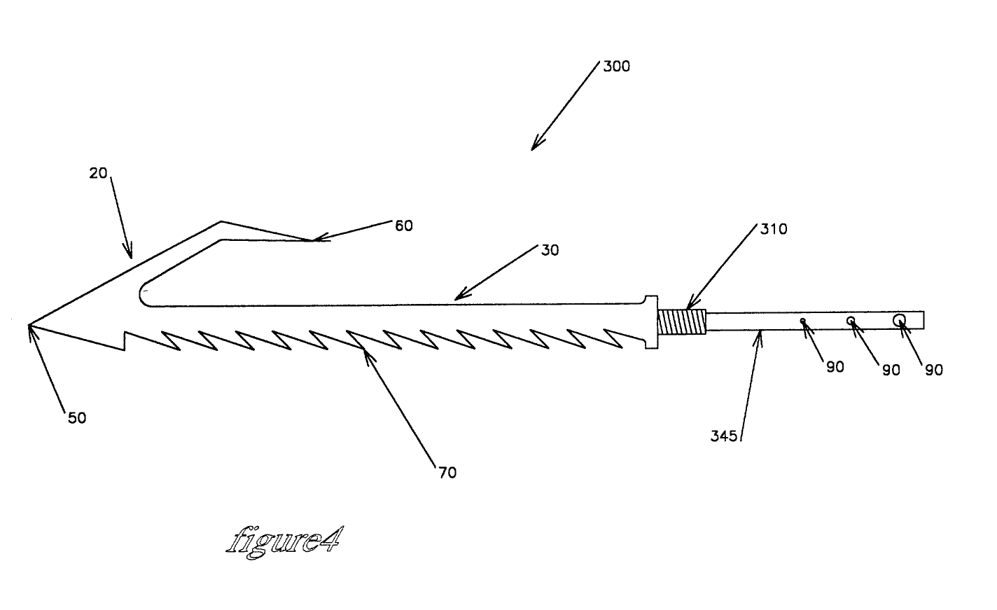

In an important aspect of the invention, the hook shaft 30 is secured to the offset rope holder 40 and continues and extends through the offset rope holder 40 to form a handle engagement portion 345 (shown in FIG. 4). The handle engagement portion 345 extends for a distance effective for detachably engaging a detachable elongated handle 80.

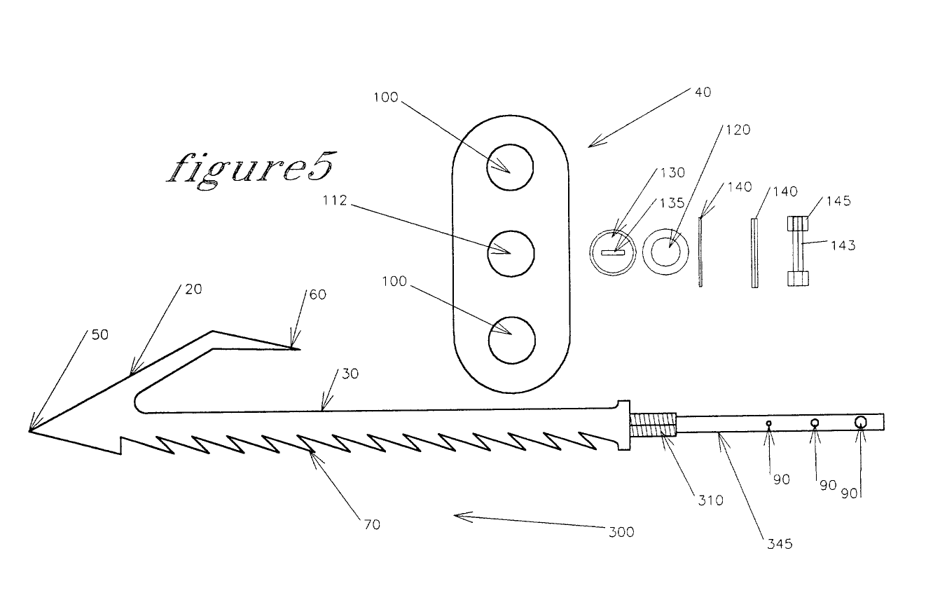

The offset rope holder 40 is threaded onto the hook shaft 30. A support collar may be threaded onto the hook shaft 30 behind the rope holder 40 to provide additional support. A handle cap 130 is threaded onto the top of elongated handle 80. The handle cap 130 includes handle cap opening 135 (shown in FIG. 5) which is slightly larger than the handle engagement portion 345. The handle engagement portion 345 is inserted through the handle cap opening 135 and extends into the elongated handle 80.

The detachable gaff head and detachable elongated handle 80 are secured together to provide a fixed predetermined breakaway shear strength. The shear strength is fixed and predetermined by selecting a material effective for shearing or breaking at a predetermined amount of shear or force. Examples of materials effective for providing a fixed predetermined breakaway shear strength include plastic, metal, ceramic, wood and rubber.

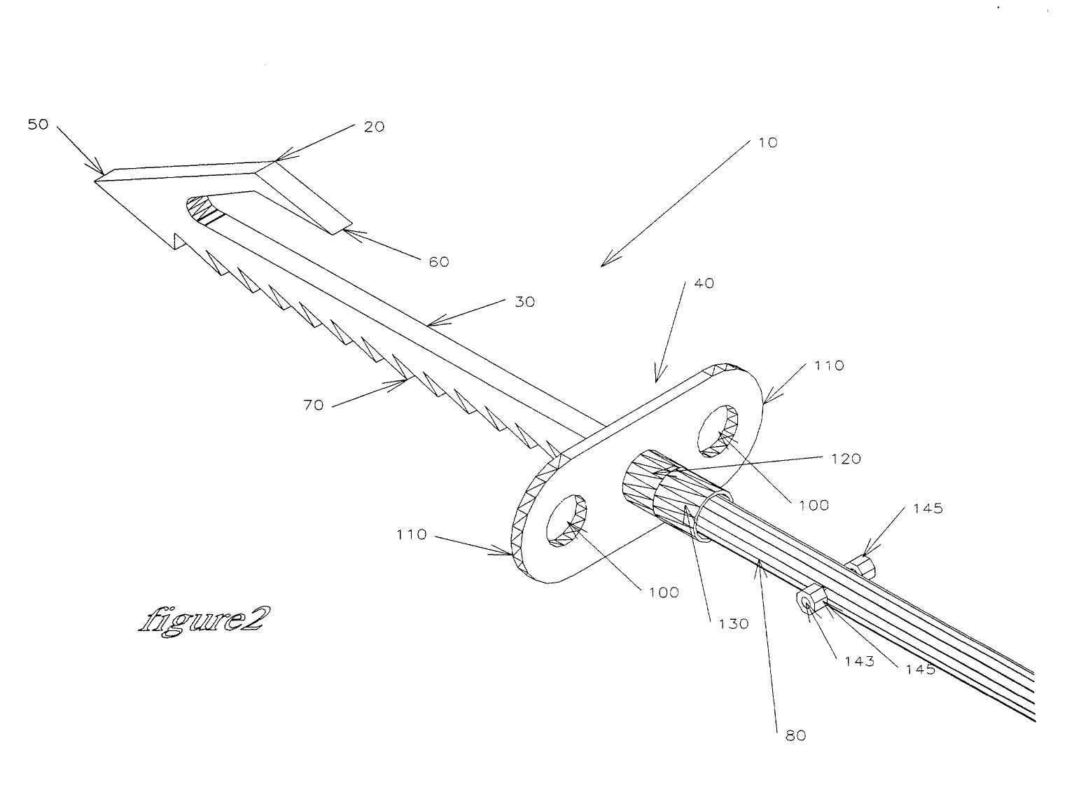

In one aspect of the invention, the handle engagement portion 345 includes at least one handle engagement shear pin hole (shown in FIG. 4) which may be matched up to at least one handle shear pin hole 95. After matching up at least one handle engagement shear pin hole 90 and at least one handle shear pin hole 95, at least one bolt 143 (shown in FIG. 2) or shear pin 140 may be inserted and extended through the holes. The shear pin 140 provides a predetermined strength effective for allowing the shear pin 140 to break and for allowing the detachable elongated handle 80 to disconnect. In an alternative aspect of the invention, a shear pin hole 95 may be located in the support collar 120, the handle cap 130, or both.

The fixed/flying gaff 10 of the invention also includes an offset rope holder 40. The offset rope holder 40 includes at least one rope hole 100 and may include two rope holes 100 as shown in FIG. 1. In an important aspect of the invention the rope hole 100 or rope holes 100 are offset such that they are towards an outside portion 110 of the offset rope holder 40. When the offset rope holder 40 is threaded onto the threaded shaft collar 310, the rope holes 100 are positioned such that they are outside of a plane formed by the hook shaft 30 and the barb 60 on the hook portion 20 and are perpendicular to the direction of the barb 60.

Prior to using the fixed/flying gaff 10 of the invention, a rope, chain or cable is attached to the fixed/flying gaff 10 by tying or securing the rope, chain or cable through one rope hole 100. When the fixed/flying gaff 10 has been inserted into a fish, the fish may thrash about which may cause the rope to tighten. The offset design of the rope hole 100 is effective for providing a twisting action that further buries the barbs in the fish and causes a more secure attachment to the fish.

After the fixed/flying gaff 10 of the invention has been inserted into a fish and the fish has been landed, the fixed/flying gaff can be easily removed without causing further damage to the flesh of the fish. The offset rope holder 40 may be unscrewed from the hook shaft 30 and the hook shaft 30 may be pushed forward through the fish.

Another aspect of the fixed/flying gaff 10 is shown in FIG. 2. In this aspect, the hook portion 20 is flared out a distance effective to provide a hook barb 60 that points away from hook point 50 and is parallel to hook shaft 30. As further shown in FIG. 2, the hook shaft 30 and detachable elongated handle 80 may be secured with bolt 143 and nuts 145.

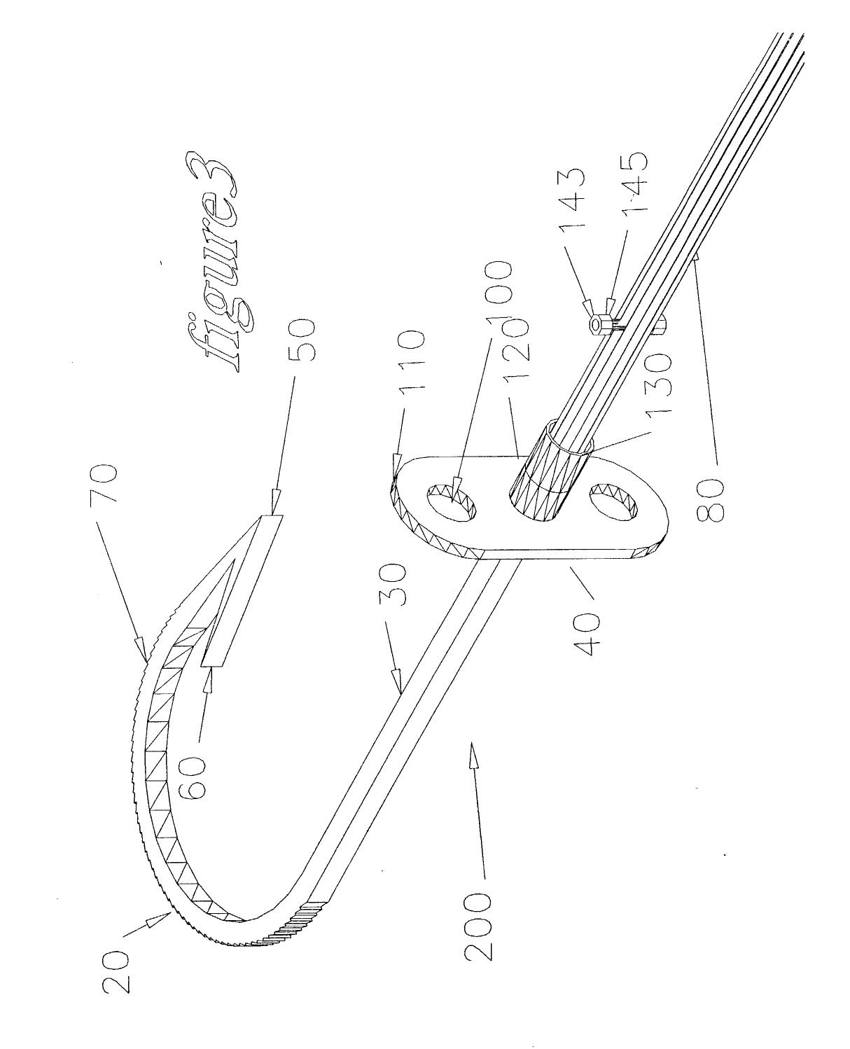

In another aspect of the invention, the fixed/flying gaff may be a rounded fixed/flying gaff 200 as shown in FIG. 3. In this aspect of the invention, the hook portion 20 is formed in a rounded or more hook-like shape. The hook portion 20 of the fixed/flying gaff 200 includes serrated teeth 70 on its hook portion 20.

FIG. 4 illustrates a view of a fixed/flying gaff head 300 without an offset rope holder and detachable elongated handle. As shown in this Figure, the fixed/flying gaff head 300 includes a threaded shaft collar 310. The hook shaft 30 extends beyond the shaft collar 310 to form a handle engagement portion 345. The handle engagement portion 345 extends for a distance effective for contacting the detachable elongated handle 80. The handle engagement portion 345 includes at least one handle engagement shear pin hole 90, and may include up to three handle engagement shear pin holes 90 as shown in the Figure.

FIG. 5 shows the fixed/flying gaff head 300 of the invention with the offset rope holder 40 detached. Upon assembly, the offset rope holder 40 is threaded onto the threaded shaft collar 310 through shaft collar opening 112. Support collar 120 is threaded onto the threaded shaft collar 310 until support collar 120 contacts the offset rope holder 40. The handle engagement portion 345 is inserted through handle cap opening 135 in handle cap 130 which is attached to one end of the detachable elongated handle 80. At least one handle engagement shear pin hole 90 is matched up with at least one handle shear pin hole 95. The hook shaft 30 and detachable elongated handle 80 are secured with at least one shear pin 140 or with a bolt 143 and nuts 145. In the aspect of the invention where at least one shear pin 140 is used, the shear pins 140 may be of different diameter and/or be made of a variety of materials to be effective for providing a predetermined shear strength. For example, a greater shear strength may be provided by using a shear pin 140 of larger diameter made of a hard plastic.

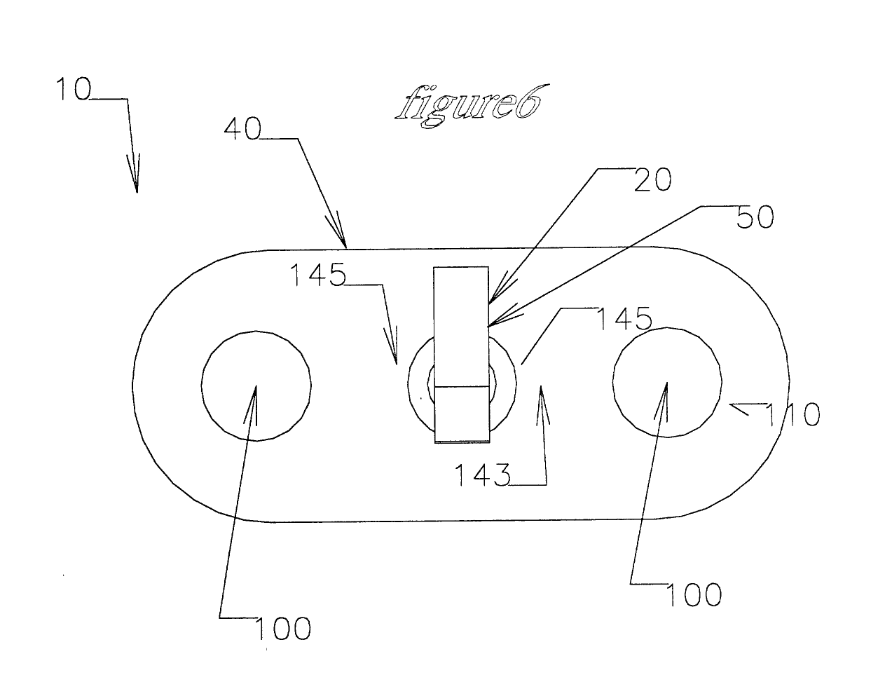

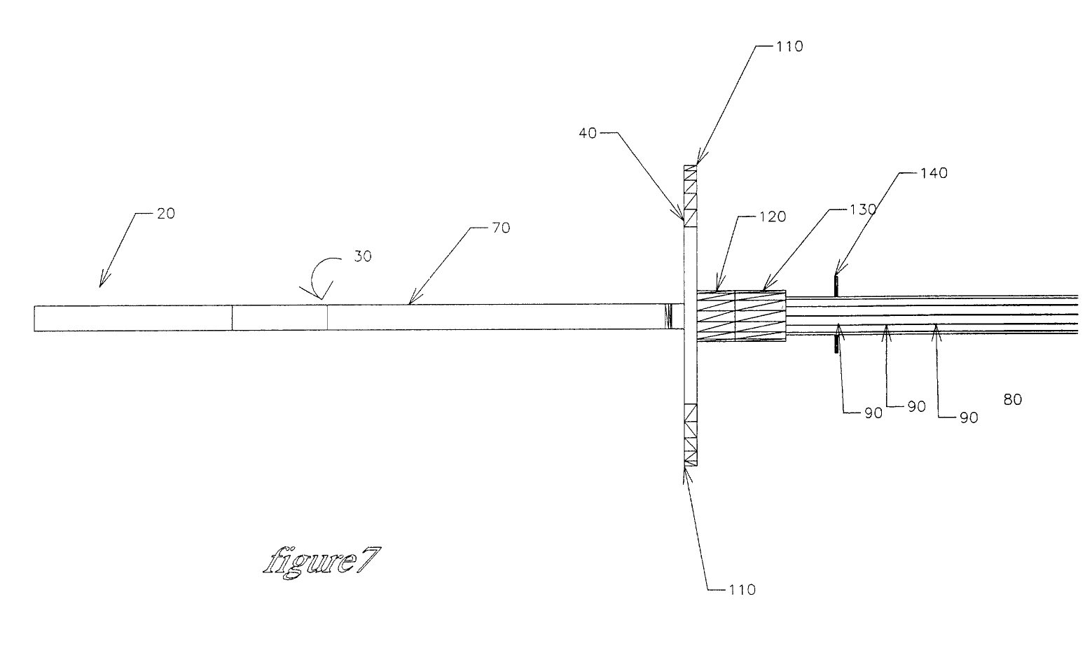

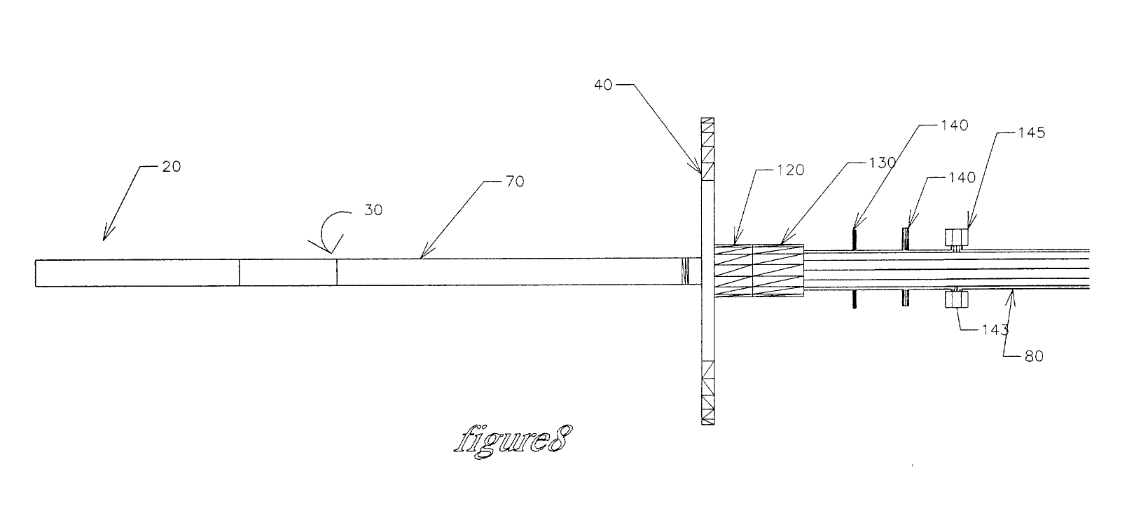

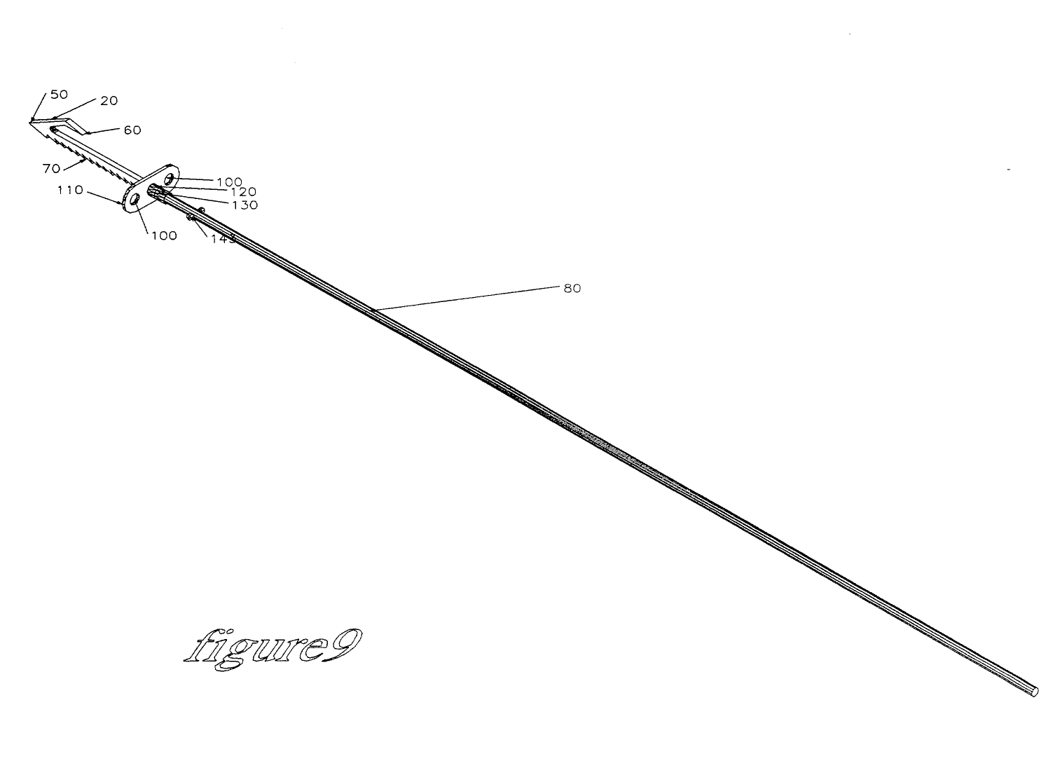

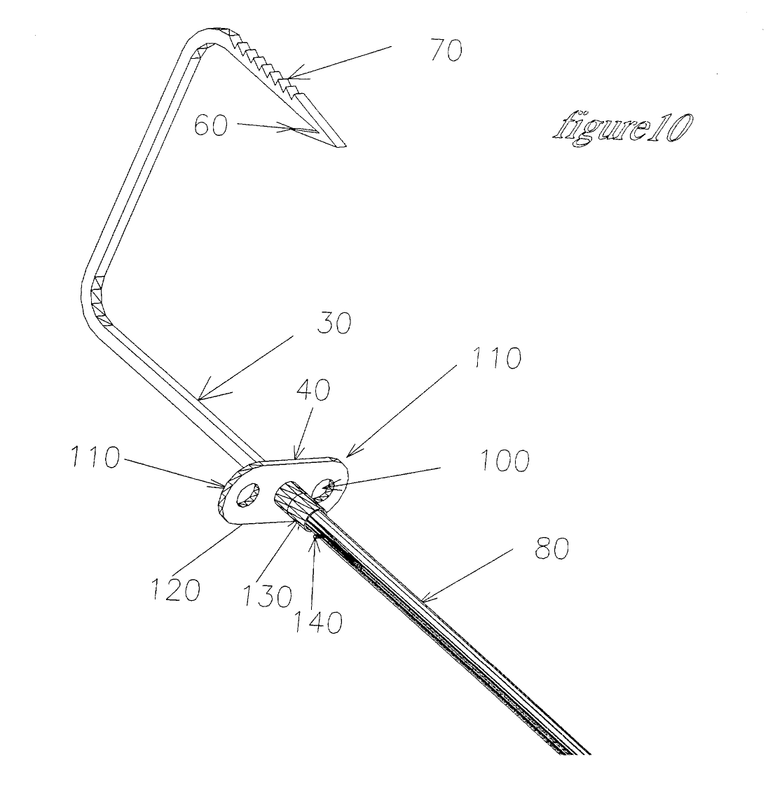

Additional views of the fixed/flying gaff of the invention are shown in FIGS. 6 to 9. In an alternative aspect of the invention, the hook portion 20 may be U-shaped as shown in FIG. 10.

The fixed/flying gaff of the invention may be made using known techniques using standard materials. For example, the fixed/flying gaff may be made out of metal, plastic, ceramic, wood or combinations thereof.

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. A fixed/flying gaff comprising a detachable gaff head and a elongated handle,
the detachable gaff head including a hook portion extending from a hook shaft, the hook shaft including serrated teeth and the hook shaft extending through a offset rope holder to provide a handle engagement portion,
the elongated handle detachably engaging the handle engagement portion.

2. The fixed/flying gaff of claim 1 wherein the hook portion includes a hook point and a hook barb.

3. The fixed/flying gaff of claim 2 wherein the offset rope holder includes at least one rope hole which is perpendicular to a direction of a barb on the hook portion.

4. The fixed/flying gaff of claim 1 wherein the hook portion is rounded and includes a hook barb.

5. The fixed/flying gaff of claim 4 wherein the offset rope holder includes at least one rope hole which is perpendicular to a direction of a barb on the hook portion.

6. The fixed/flying gaff of claim 1 wherein the hook portion is U-shaped and includes a hook barb.

7. The fixed/flying gaff of claim 6 wherein the offset rope holder includes at least one rope hole which is perpendicular to a direction of a barb on the hook portion.

8. The fixed/flying gaff of claim 1 wherein the handle engagement portion is secured to the elongated handle with at least one shear pin effective for breaking at a predetermined shear strength.

9. The fixed/flying gaff of claim 1 wherein the handle engagement portion is secured to the elongated handle with at least one bolt.

10. A fixed/flying gaff comprising:
a hook shaft;
a hook portion extending from the hook shaft, the hook portion including a hook barb;
serrated teeth on at least one of the hook portion or hook shaft;
a detachable offset rope holder detachably engaging the hook shaft, the detachable offset rope holder including at least one rope hole perpendicular to a direction of the hook barb;
a handle engagement portion; and
an elongated handle,
the handle engagement portion extending into the elongated handle.

11. The fixed/flying gaff of claim 10 wherein the hook portion includes a hook point and a hook barb.

12. The fixed/flying gaff of claim 10 wherein the hook portion is rounded and includes a hook barb.

13. The fixed/flying gaff of claim 10 wherein the hook portion is U-shaped and includes a hook barb.

14. The fixed/flying gaff of claim 10 wherein the handle engagement portion is secured to the elongated handle with at least one shear pin effective for breaking at a predetermined shear strength.

15. The fixed/flying gaff of claim 10 wherein the handle engagement portion is secured to the elongated handle with at least one bolt.

16. A method for landing a fish comprising inserting a fixed/flying gaff into a fish and retrieving the fixed/flying gaff and fish,
wherein the fixed/flying gaff includes a detachable gaff head and a elongated handle,
the detachable gaff head including a hook portion extending from a hook shaft, the hook shaft including serrated teeth and the hook shaft extending through a detachable offset rope holder to provide a handle engagement portion,
the elongated handle detachably engaging the handle engagement portion.

17. The method of claim 16 wherein the hook portion includes a hook point and a hook barb.

18. The method of claim 17 wherein the offset rope holder includes at least one rope hole which is perpendicular to a direction of a barb on the hook portion.

19. The method of claim 16 wherein the hook portion is rounded and includes a hook barb.

20. The method of claim 19 wherein the offset rope holder includes at least one rope hole which is perpendicular to a direction of a barb on the hook portion.

21. The fixed/flying gaff of claim 16 wherein the hook portion is U-shaped and includes a hook barb.

22. The method of claim 21 wherein the offset rope holder includes at least one rope hole which is perpendicular to a direction of a barb on the hook portion.

23. The method of claim 16 wherein the handle engagement portion is secured to the elongated handle with at least one shear pin effective for breaking at a predetermined shear strength.

24. The method of claim 16 wherein the handle engagement portion is secured to the elongated handle with at least one bolt.

25. A fixed/flying gaff comprising a detachable gaff head and a elongated handle,
the detachable gaff head including a hook portion extending from a hook shaft, the hook shaft including serrated teeth and the hook shaft extending to provide a handle engagement portion,
the elongated handle detachably engaging the handle engagement portion.

26. The fixed/flying gaff of claim 25 wherein the hook portion includes a hook point and a hook barb.

27. The fixed/flying gaff of claim 26 further comprising an offset rope holder with at least one rope hole which is perpendicular to a direction of a barb on the hook portion.

28. The fixed/flying gaff of claim 27 wherein the offset rope holder is detachable.

29. The fixed/flying gaff of claim 25 wherein the hook portion is rounded and includes a hook barb.

30. The fixed/flying gaff of claim 29 further comprising an offset rope holder with at least one rope hole which is perpendicular to a direction of a barb on the hook portion.

31. The fixed/flying gaff of claim 30 wherein the offset rope holder is detachable.

32. The fixed/flying gaff of claim 25 wherein the hook portion is U-shaped includes a hook barb.

33. The fixed/flying gaff of claim 32 further comprising an offset rope holder with at least one rope hole which is perpendicular to a direction of a barb on the hook portion.

34. The fixed/flying gaff of claim 33 wherein the offset rope holder is detachable.

35. The fixed/flying gaff of claim 25 wherein the handle engagement portion is secured to the elongated handle with at least one shear pin effective for breaking at a predetermined shear strength.

36. The fixed/flying gaff of claim 25 wherein the handle engagement portion is secured to the elongated handle with at least one bolt.

37. A fixed/flying gaff comprising a detachable gaff head and a elongated handle,
the detachable gaff head including a hook portion extending from a hook shaft, the hook shaft extending to provide a handle engagement portion,
the elongated handle detachably engaging the handle engagement portion with a fixed predetermined breakaway shear strength.

38. The fixed/flying gaff of claim 37 wherein the hook portion includes a hook point and a hook barb.

39. The fixed/flying gaff of claim 38 further comprising an offset rope holder with at least one rope hole which is perpendicular to a direction of a barb on the hook portion.

40. The fixed/flying gaff of claim 39 wherein the offset rope holder is detachable.

41. The fixed/flying gaff of claim 37 wherein the hook portion is rounded and includes a hook barb.

42. The fixed/flying gaff of claim 41 further comprising an offset rope holder with at least one rope hole which is perpendicular to a direction of a barb on the hook portion.

43. The fixed/flying gaff of claim 42 wherein the offset rope holder is detachable.

44. The fixed/flying gaff of claim 37 wherein the hook portion is U-shaped includes a hook barb.

45. The fixed/flying gaff of claim 44 further comprising an offset rope holder with at least one rope hole which is perpendicular to a direction of a barb on the hook portion.

46. The fixed/flying gaff of claim 45 wherein the offset rope holder is detachable.

47. The fixed/flying gaff of claim 37 wherein the handle engagement portion is secured to the elongated handle with at least one shear pin effective for breaking at a predetermined shear strength.

48. The fixed/flying gaff of claim 37 wherein the handle engagement portion is secured to the elongated handle with at least one bolt.
